(19) United States
(12) Patent Application Publication
(10) Pub. No.: US 2019/0234057 A1
(43) Pub. Date: Aug. 1, 2019

(54) Toilet Flange

(71) Applicant: Gabriel Couture, Longueuil (CA)

(72) Inventor: Gabriel Couture, Longueuil (CA)

(21) Appl. No.: 16/260,948

(22) Filed: Jan. 29, 2019

Related U.S. Application Data
(60) Provisional application No. 62/624,500, filed on Jan. 31, 2018.

(51) Int. Cl. E03D 11/17; E03D 11/16

(52) U.S. Cl. CPC E03D 11/17; F16J 15/022; E03D 11/16

(57) ABSTRACT

A toilet flange includes a body that is a made of a rigid material and that includes i) a hollow cylindrical portion having two longitudinal ends, and ii) a flange portion that extends radially outward from the hollow cylindrical portion at one of the two longitudinal ends thereof; and an annular seal member that is made of a resilient material and that is integrated into the one-piece body so as to extend from the flange portion on a side thereof opposite the hollow cylindrical portion coaxially therewith. The resiliency of the seal member allows a range of movement thereof during installation of a toilet bowl to the toilet flange. This contributes to maintaining the integrity of the seal. Also, the integration of the seal member to the body prevents displacement of the seal relative to the body, yielding a more precise installation of the toilet bowl.

### CROSS REFERENCE TO RELATED PATENT APPLICATION

This application claims the benefit of U.S. Provisional Application No. 62/624,500, filed on Jan. 31, 2018, the content of which is incorporated by reference herein.

### BACKGROUND

The present disclosure concerns toilet bowl installations. More specifically, the present disclosure is concerned with a toilet flange for such an installation.

A typical toilet flange is composed of a polymeric hub with a round mounting flange attached to the top.

In a typical installation, the toilet flange is mounted to the floor with the hub fused around the drain pipe. A wax ring is used to seal the gap between the flange and the bottom of the toilet. The toilet is then bolted to the flange, not to the floor.

U.S. Pat. No. 3,821,820, issued to Thompson on Jul. 2, 1974 and titled “Gasket for Sealing Outlet Connection of a Toilet Bowl” describes a toilet flange that incorporates a wax ring. A plastic annular is embedded on the wax ring to form an annular ridge thereon for sealing engagement with the outer wall of the outlet of the toilet bowl.

A drawback of the toilet flange from Thompson is that the wax ring is permanently deformable and is therefore prone to breakage or deformation when a toilet bowl is not successfully installed the first time. This causes the joint between the toilet and outlet to be imperfect. Moreover, the installation must be precise considering that minimal movement is allowed by the toilet flange around the outlet during installation. Furthermore, the wax ring has to be changed with each new installation. Also, a plastic annular has to be added on the wax ring to improve the sealing engagement with the outer wall of the outlet of the toilet bowl. This adds to the complexity on the manufacturing process. Finally, the flange portion 31 is completely embedded in the wax ring, causing instability when the flange is to be secured directly to the floor.

U.S. Pat. No. 3,400,411, issued to Harvey on Sep. 10, 1968 and titled “Sealing Gasket Means” teaches sealing means that replace the wax-ring by a foam-based ring that is filled with wax. This appears to solve at least partially the rigidity problem of the gasket from Thompson while complexifying the assembly of the overall gasket. Moreover, compression of the gasket during installation is likely to cause some wax material to exit the foam, resulting in an imperfect seal. Also, similarly to Thompson, the flange is either completely embedded in the ring or it is mounted thereon after the ring is secured to the floor.

More recent toilet flanges have been introduced that aims to solve the above-drawbacks. However, these toilet flanges include many parts and relatively complex assembly.

### SUMMARY

The problem of damaging the seal on a toilet flange during installation of a toilet bowl thereon is solved by integrating a variable length seal made of a resilient material into the flange portion of the toilet flange.

According to an illustrative embodiment, there is provided a toilet flange comprising:

a body that is a made of a rigid material and that includes i) a hollow cylindrical portion having two longitudinal ends, and ii) a flange portion that extends radially outward from the hollow cylindrical portion at one of the two longitudinal ends thereof; and

an annular seal member that is made of a resilient material and that is integrated to the body so as to extend from the flange portion on a side thereof opposite the hollow cylindrical portion coaxially therewith.

The resiliency of the seal member allows a range of movements thereof during installation of a toilet bowl to the toilet flange. This contributes to maintaining the integrity of the seal. A longer seal than the installation would normally require can also be provided, the resiliency thereof allowing an automatic adjustment of its height during installation.

Also, the fact that the seal member is integrated to the body prevents displacement of the seal relative to the body, yielding a more precise installation of the toilet bowl.

According to another illustrative embodiment, there is provided a toilet flange comprising:

a one-piece plastic body that includes i) a hollow cylindrical portion having two longitudinal ends, and ii) a flange portion that extends radially outward from the hollow cylindrical portion at one of the two longitudinal ends thereof; and

an annular seal member that is made of a resilient material; the annular seal member having a sealing portion that extends from the flange portion of the one-piece plastic body and a connector portion that is integrated to the flange portion of the one-piece plastic body during a molding process so as to extend from the flange portion on a side thereof opposite the hollow cylindrical portion coaxially therewith.

According to still another illustrative embodiment, there is provided a toilet flange comprising:

a body that is a made of a rigid material and that includes i) a hollow cylindrical portion having two longitudinal ends, and ii) a flange portion that extends radially outward from the hollow cylindrical portion at one of the two longitudinal ends thereof; the flange portion including two bolt-receiving housings that are so positioned relative to the hollow cylindrical portion to locate a toilet bowl onto the toilet flange.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Other objects, advantages and features of embodiments of a toilet flange will become more apparent upon reading the following non-restrictive description of preferred embodiments thereof, given by way of example only with reference to the accompanying drawings.

Unless otherwise specifically noted, articles depicted in the drawings are not necessarily drawn to scale.

### BRIEF DESCRIPTION OF THE DRAWINGS

In the appended drawings:

FIG. 1 is a perspective view of a toilet flange according to a first illustrative embodiment;

FIG. 2 is an exploded view of the toilet flange from FIG. 1;

FIG. 3 is a top plan view of the toilet flange from FIG. 1; the size markings thereon being included for illustrative purposes only;

FIG. 4 is a cross section taken from line 4-4 in FIG. 3;

FIG. 5 is a close-up view of the integrated seal member in the flange from FIG. 4;

FIG. 6 is a cross section similar to FIG. 4, illustrating the mounting of a second seal member on the integrated seal member;

FIG. 7 is a close-up view similar to FIG. 5, showing the second seal member of FIG. 6, mounted to the integrated seal member;

FIG. 8 is a perspective view of the flange from FIG. 7, showing the further mounting of a third seal member thereon;

FIG. 9 is an exploded view of the installation of a toilet bowl using the flange from FIG. 1 and an additional removable seal member;

FIG. 10 is a perspective view of a toilet flange according to a second illustrative embodiment;

FIG. 11 is a sectional perspective view of the toilet flange from FIG. 10, taken along line 11-11 in FIG. 10;

FIG. 12 is an exploded sectional perspective view of the toilet flange from FIG. 11, taken along line 12-12 in FIG. 10;

FIG. 13 is a perspective view of a toilet flange according to a third illustrative embodiment; and

FIG. 14 is a perspective view of a toilet flange according to a fourth illustrative embodiment.

### DETAILED DESCRIPTION

In the following description, similar features in the drawings have been given similar reference numerals, and in order not to weigh down the figures, some elements are not referred to in some figures if they were already identified in a precedent figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, un-recited elements.

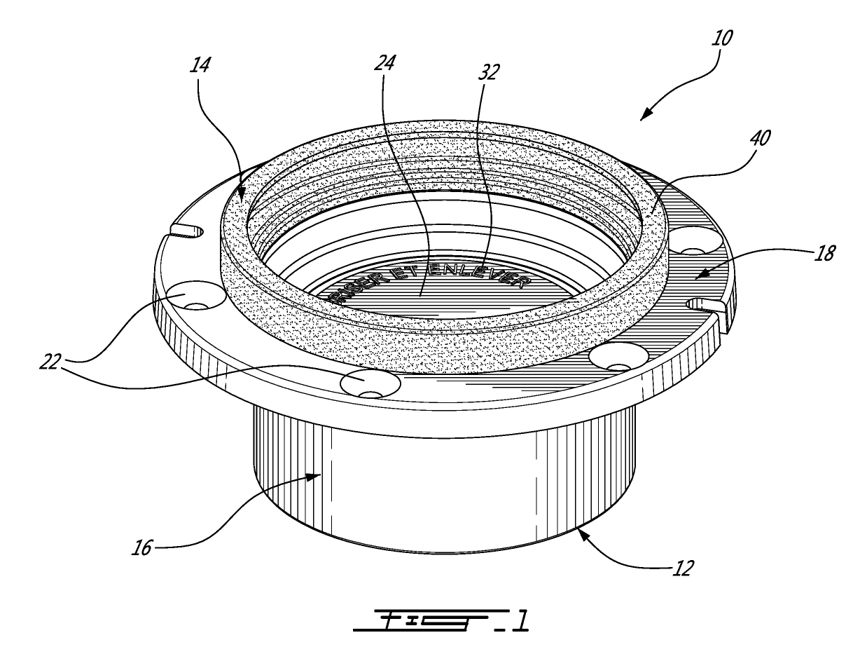

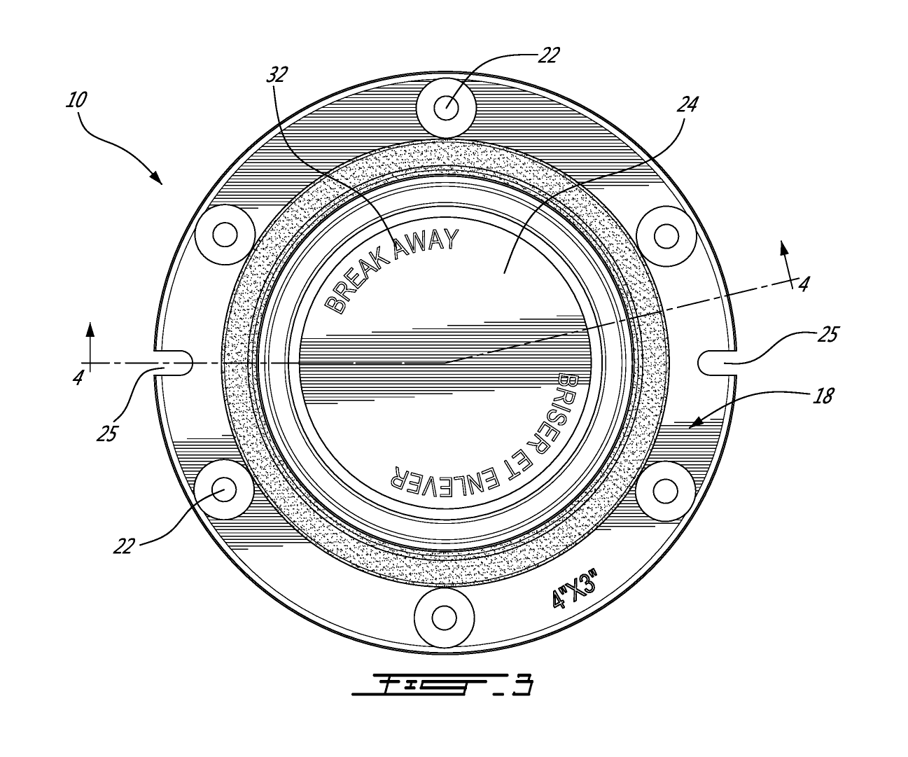

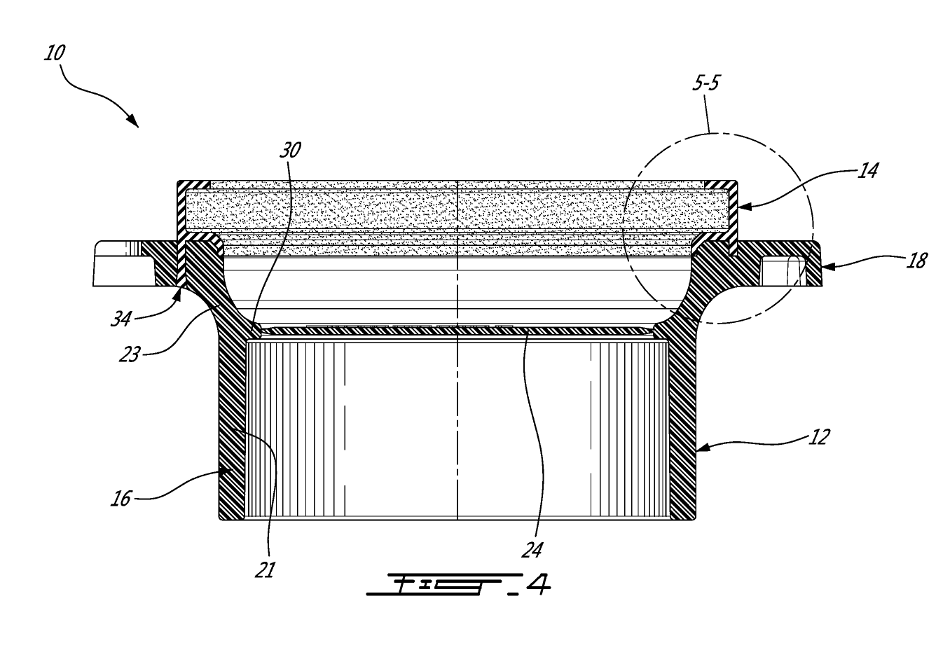

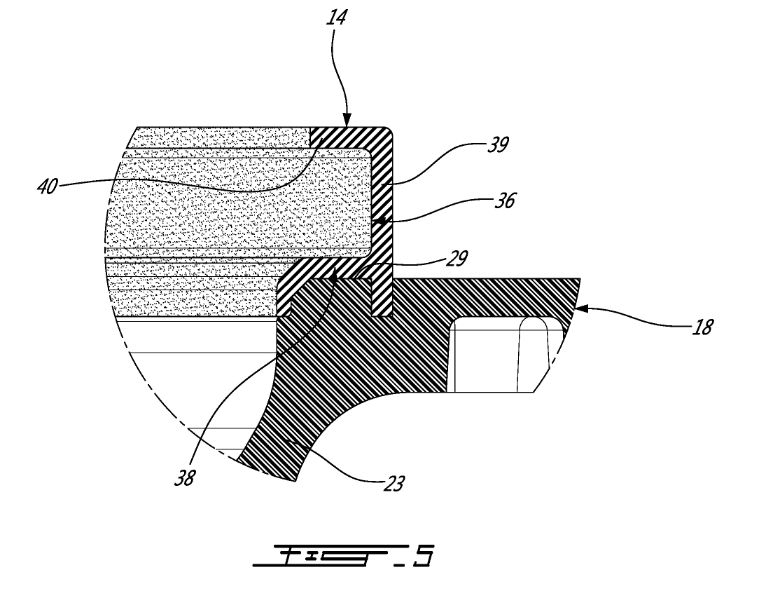

A first illustrative embodiment of a toilet flange 10 will now be described with reference to FIGS. 1 to 5.

The toilet flange 10 comprises a one-piece plastic body 12 and an annular seal member 14 integrated to the body 12. The toilet flange 10 is manufactured by molding the one-piece body 12 first and then by overmolding the annular seal member thereon.

The body 12 has a hollow cylindrical portion 16 and a flange portion 18 that extends radially outward from the cylindrical portion 16 at a longitudinal end thereof. The cylindrical portion 16 has a straight portion 21 that is dimensioned to snugly fit into a drain pipe (not shown) and an enlargement portion 23 that defines a bridge between the flange portion 18 and the straight portion 21 of the body 12.

A plurality of equidistant rounded recesses 22 are provided on the flange portion 18 for receiving fasteners (not shown) when securing the flange 10 to the floor (not shown). The recesses 22 serve as positioning guides for the fasteners while allowing to preserve the watertightness of the flange portion 18.

According to another embodiment, the recesses 22 are replaced by holes. According to still another embodiment, the recesses 22 or holes are omitted.

It is to be noted that the underside of the flange 18 is generally flat, which improve the stability of the installation thereof on an even floor (not shown).

The top of the flange is provided with a circular groove 27 that defines a narrow ring portion 29. The circular groove 27 further includes a plurality of holes 45 therein. The purpose of the groove 27, ring 29 and holes 45 will be described hereinbelow.

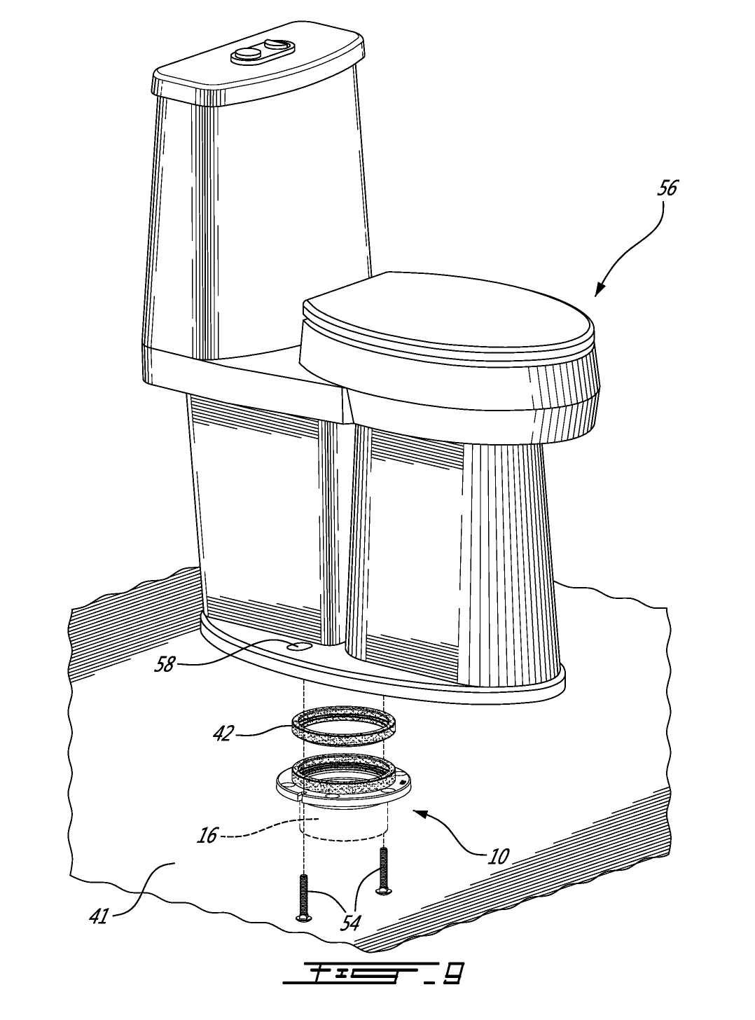

Two radially opposite peripheral oblong notches 25 are provided to received hold-on bolts 54 (see on FIG. 9) for securing the toilet bowl 56 to the toilet flange 10. Two of the holes 22 can alternatively be used for that purpose.

A removable disk 24 is provided within the upper edge 26 of the straight portion 21 that further closes the opening 28 of the cylindrical portion 16. The disk 34 yields an air tight assembly to prevent odor from the drain pipe when the toilet flange 10 is mounted thereon before the toilet bowl 56 is mounted to the flange 10.

The peripheral edge 30 of the disk 24 is narrower than the remaining part thereof, defining a weakness that facilitates the detachment of the disk 24 from the annular wall 22. Markings 32 to that effect are inscribed on the disk 24. According to another embodiment (not shown), such markings are omitted. According to still another embodiment (not shown), the disk 24 is omitted.

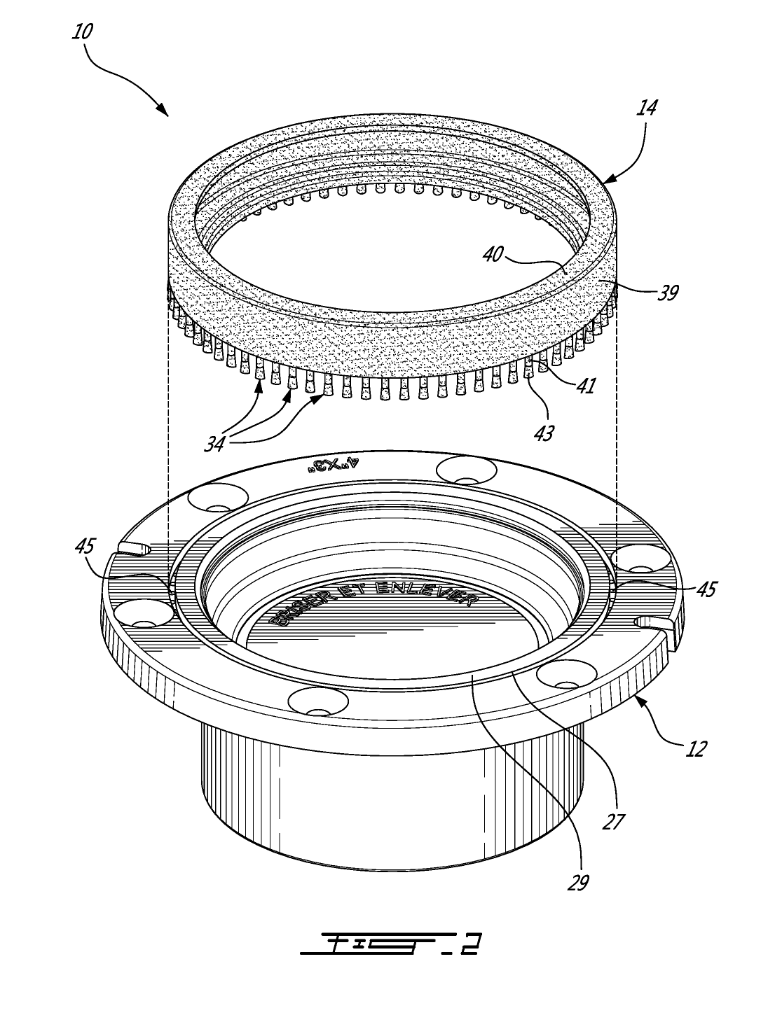

With reference now to FIGS. 2, 4 and 5, the annular seal member 14, which is made of rubber or of another resilient material, will now be described in more detail.

The annular seal member 14 has a sealing portion 36 that has a generally C-shaped section and a connector portion that results from the overmolding of the annular seal member 14 onto the one-piece body 12. Indeed, the groove 27 and ring 29 of the flange portion 18 defines a generally U-shaped connector portion 38 of the annular seal member 14. Moreover, the holes 45 of the flange portion 18 creates small stems 34 that strengthen the anchoring of the annular seal member 14 onto the flange 18 of the one-piece body 12.

More specifically, each of the stems 34 includes a straight portion 41 that extends from the U-shaped portion 38 and a frustoconical tip portion 43 that extends from the straight portion 41 coaxially therefrom.

The C-shaped sealing portion 36 is defined by a top annular portion 40 that defines a top edge of the toilet flange 10, and iii) a straight portion 39 that acts as a bridge between and the top portion 40 and U-shaped connector portion 38.

As will be described hereinbelow with reference to further illustrative embodiments of the toilet flange, the annular seal member and more specifically its connector portion are not limited to the embodiment shown in FIGS. 2.

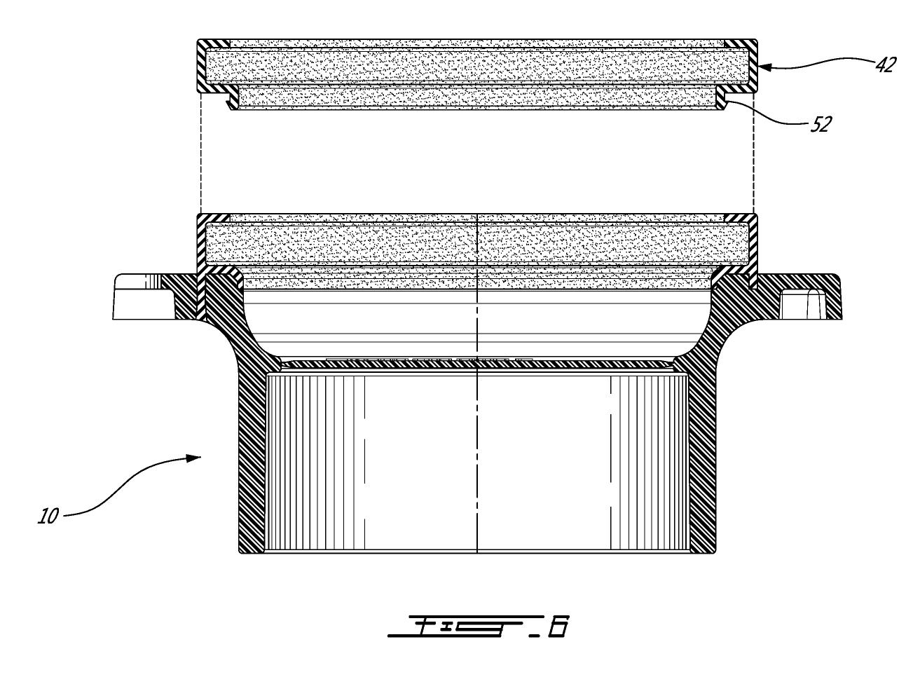

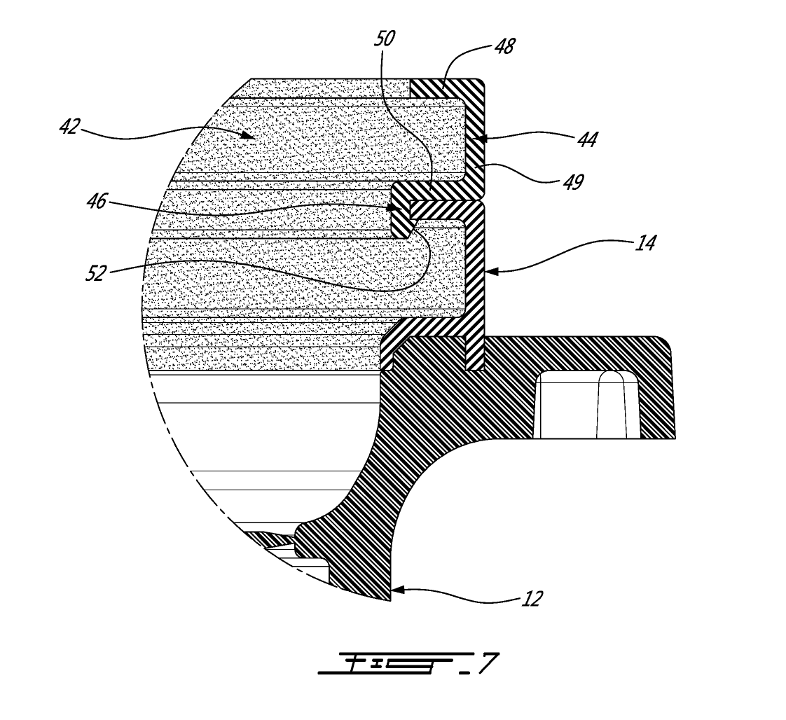

As shown in FIGS. 6 and 7, a secondary C section annular seal member 42 can be attached to the toilet flange 14 when further height is required for the flange 14. Indeed, an additional length may be required for the flange when the top edge of the flange-receiving hole (not shown) is below the floor level for example.

With reference to FIG. 7, the secondary seal member 42 is similar to the main seal member 14 and includes a C section annular portion 44 that is defined by top and bottom parallel annular flat portions 48 and 50 and a straight portion 49 between the bottom and top annular portions 48 and 50, that acts as a bridge between both portions 48 and 50. The secondary seal member 42 further includes a skirt portion 46 that extends perpendicularly from the bottom annular flat portion 50. The skirt portion 46 includes an annular ridge 52 at the distal end thereof.

The skirt 46 defines a hook which grabs onto the seal member 14 when it is concentrically mounted thereon. In addition to having an increased height compared to the integrated seal member 14, the resulting assembly of the two seal members 14 and 42 remains tight and resilient.

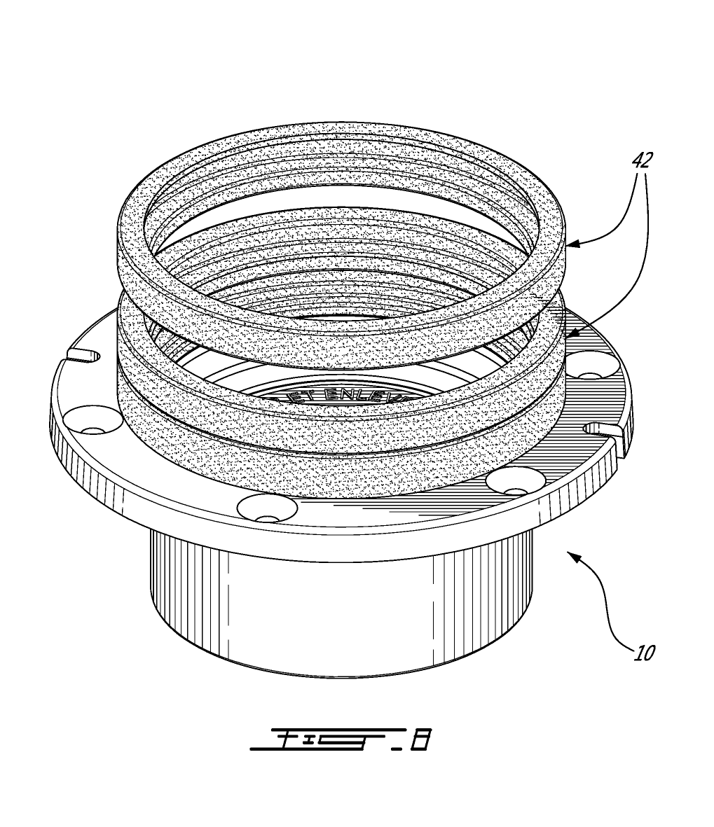

As can be seen in FIG. 8, any number of such additional seal members 42 can be mounted on top of the other and secured to the flange 10 to increase the height thereof. The assembly of the main seal 14 and one or more secondary seal members 42 thereon can be seen as a variable length seal.

While the embodiment of the secondary seal member 42 is shown in FIGS. 6 to 8 as being of similar height than the main seal member 14, seal members of different heights can be provided and assembled to the main seal member 14.

FIG. 8 illustrates the fixation of a conventional toilet bowl 44 to the floor 41 using the toilet flange 10.

The cylindrical portion 16 of the flange 10 is first inserted into the drain pipe (not shown).

A couple of hold-down bolts 54 are inserted in the notches 25 or in two of the fastener-receiving holes 22 of the flange 18 and the flange 18 is then secured to the floor by using fasteners (not shown) in the fastener-receiving holes 22 while the hold down bolts are maintained in the notches 25.

Finally, the bowl 56 is secured to the floor 41 by positioning the bowl 56 onto the toilet flange 10 in such a way that the hold-down bolts 54 are inserted in the bolt-receiving holes 58 (only one shown) of the bowl 56 and by securing washers and nuts (both not shown).

A person skilled in the art will appreciate that the installation of a conventional wax-seal (not shown) onto the flange 10 is unnecessary considering the presence of the integrated seal member 14. Also, as stated hereinabove, the height of the seal member 14 can be adjusted by adding one or more secondary seal members 42.

Furthermore, it would also be appreciated that, the seal member 14 being made of a resilient material, it will not be permanently deformed should an installer fail to correctly align the bowl 56 and toilet flange 10 during installation.

Since securing a toilet bowl to a floor and more generally installing a toilet bowl are believed to be well-known in the art, such operations will not be described herein in more detail for concision purposes.

Even though the main body 12 of the flange 10 has been described as a one-piece plastic body, it can be made from another material and/or be assembled from a plurality of pieces.

The main body can be differently shaped than the embodiment shown for example in FIG. 1.

The seal member 14 is also not limited to being integrated to the main body 12 during a molding process thereof. According to another embodiment, the integrated seal member is secured to the main body 12 using fastening means such as, without limitations, an adhesive.

The seal member 14 integrated to the flange 10 is not limited to the illustrated embodiment. For example, the seal member 14 is not limited to being made of rubber and can be made of any other resilient and/or non-permanently deformable material, such as, without limitations, expanded rubber.

The integrated seal member can have another configuration or size than illustrated. Also, the cooperating elements between the integrated seal member 14 and secondary seal member 42 can also be different than illustrated.

According to another embodiment (not shown), the seal member integrated to the flange 10 is provided with a portion that can be rolled-up to adjust the height thereof.

Other modifications can be made to the toilet flange 10, as will now be described with reference to further illustrative embodiments.

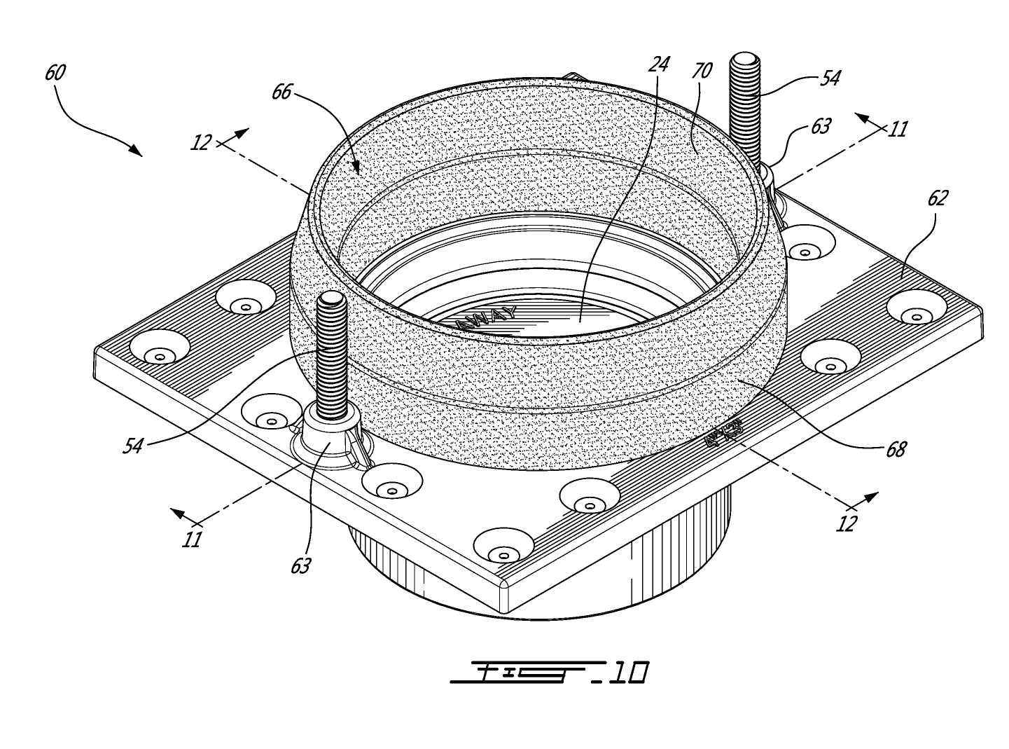

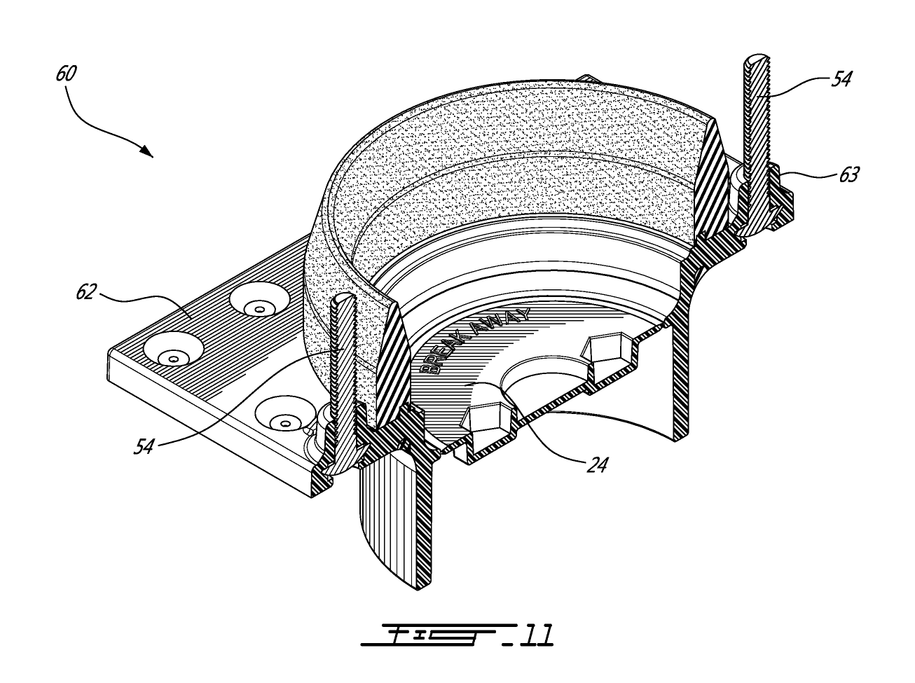

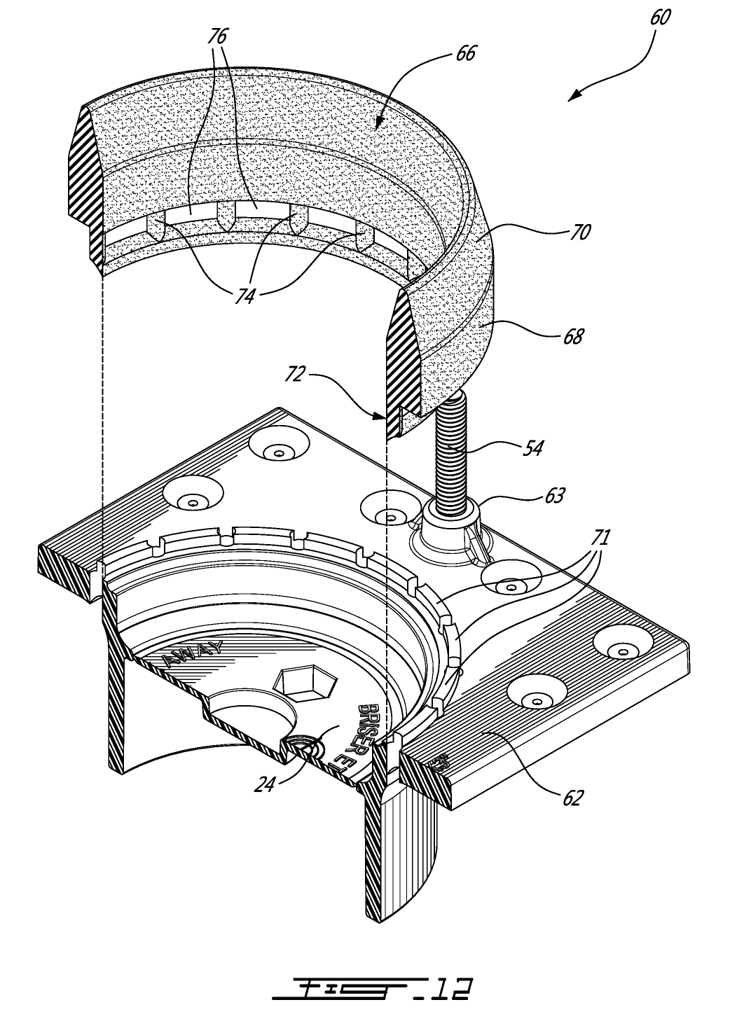

A toilet flange 60 according to a second illustrative embodiment will now be described with reference to FIGS. 10 to 12. Since the toilet flange 60 is similar to the toilet flange 10, only the differences therebetween will be described herein in more detail for concision purposes.

The toilet flange 60 includes a flange portion 62 which is rectangular. The rectangular peripheral edge of the portion 62 can be used as a guide to orient the flange 60 so that it is align, for aesthetic purposes, with a wall, a cabinet or with any other surrounding structure (all not shown). This will further result in the automatic alignment of the toilet bowl 56 when it will be secured to the flange 60 using the bolts 54.

Two hold-down bolts 54 are integrated to the flange portion 62. For that purpose, bolt-housings 63 are provided in diametrically opposite locations within the flange portion 62. The bolts 54 can be integrated during the moulding of the flange portion 62 or added in the housing before installation of the flange 60.

The integration of the bolt 54 to the flange portion 62 allows using the bolts 54 as fixed positioning guide for the toilet bowl 56 during its installation. The location of the housings 63 relative to the central opening of the toilet flange 60 is such as to insure the alignment of the toilet bowl 56 with the flange 60.

The toilet flange 60 comprises an integral one-piece seal member 66. The seal member 66 includes a rectangular annular portion 68, a rounded triangular-shaped annular portion 70 extending from the rectangular portion 68 coaxially on a first side thereof opposite the flange portion 62, and an annular connector portion 72 that extends from the rectangular portion 68 on the side thereof opposite the triangular-shaped portion 70. The connector portion 72 is formed during the overmolding of the annular seal member 66 by a series of arcuate protrusions 71 on the flange portion 62 that together defines a ring.

It results that the connector portion 72 includes a series of alternating ridges 74 and rectangular holes 76 along its inner peripheral side, which aim at increasing the surface contact between the connector portion 72 of the seal member 66 and the flange portion 62 of the body. This improves the attachment of the seal member 66 to the flange portion 62.

The height of the seal member 66 is greater than the height of the seal member 14 of the toilet flange 10, which renders the need to add a supplemental seal useless in most installation.

Furthermore, the tapered profile of the seal member 66 has been found to facilitate and improve the connection of the seal member 66 to the toilet bowl outlet (not shown) during installation of the toilet bowl 56 onto the toilet flange 60.

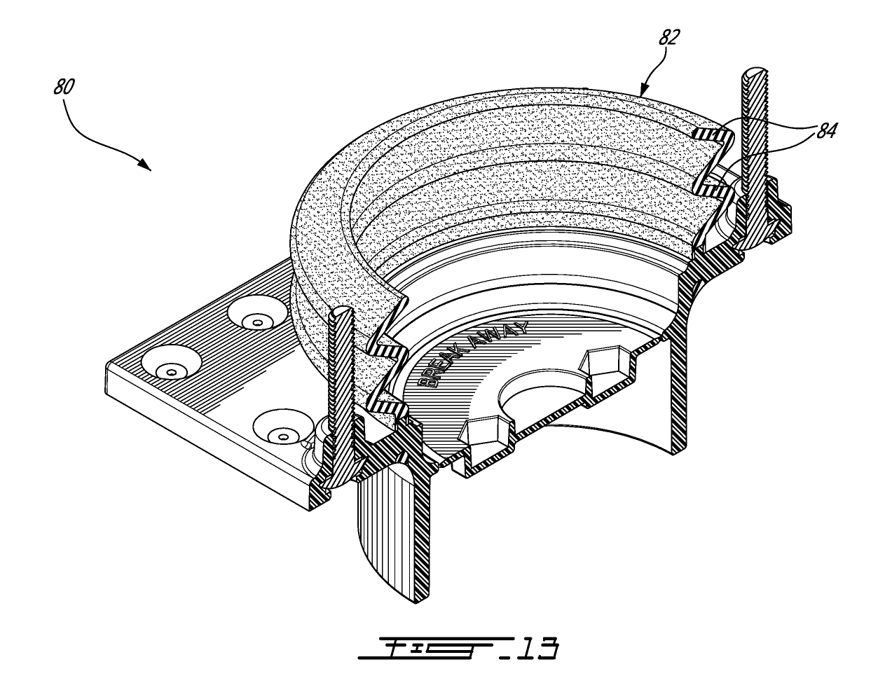

With reference now to FIG. 13, a toilet flange 80 according to a third illustrative embodiment will now be described. Since the toilet flange 80 is similar to the toilet flange 60, only the differences therebetween will be described herein for concision purposes.

The toilet flange 80 includes an accordion-shaped annular seal member 82 defined by two superimposed V-shaped annular layer 84. According to another embodiment (not shown), a similar toilet flange includes another number of layers 84.

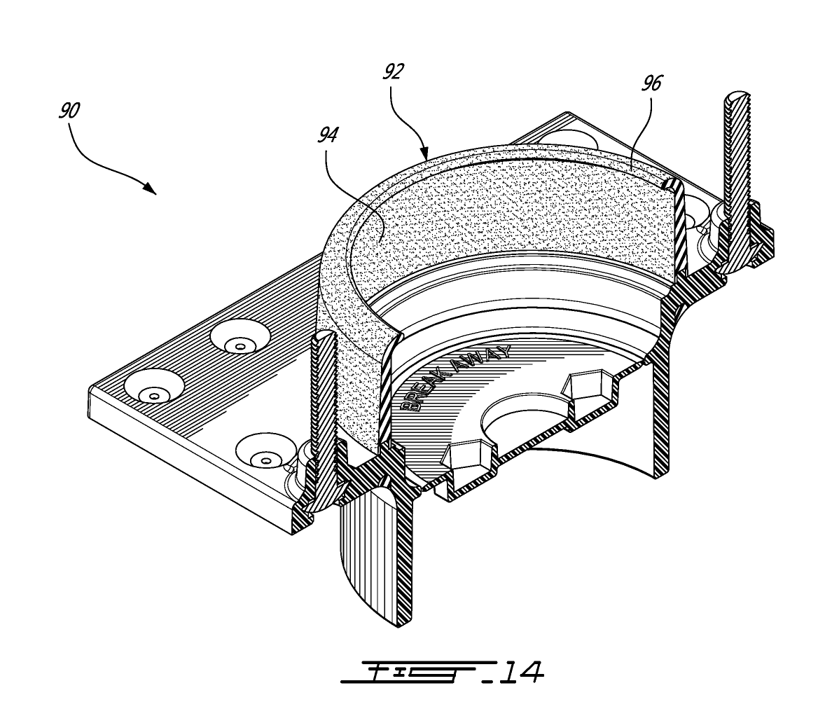

With reference now to FIG. 14, a toilet flange 90 according to a third illustrative embodiment will now be described. Since the toilet flange 90 is similar to the toilet flange 60, only the differences therebetween will be described herein for concision purposes.

The toilet flange 90 includes a cylindrical seal member 92 comprising a hollow tube portion 94 having, at its distal end, an integral arcuate flange 96 extending therefrom radially inwardly.). The distal end of the hollow tube portion 94 is shaped so as to roll over inwardly when the top end of the seal member 92 contacts an inner wall of the toilet bowl 56. It results that the height of the seal member 92 automatically adapts to the space available within the bowl.

It is to be noted that the relative height of the annular seal member 14, 42, 66, 82 or 92 is for illustrative purposes only and may vary.

Although a toilet flange has been described hereinabove by way of illustrated embodiments thereof, it can be modified. Modifications, additions, or omissions may be made to the toilet flanges described herein without departing from the scope of the disclosure. Moreover, the operations of the systems and devices disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A toilet flange comprising:
a body that is a made of a rigid material and that includes i) a hollow cylindrical portion having two longitudinal ends, and ii) a flange portion that extends radially outward from the hollow cylindrical portion at one of the two longitudinal ends thereof; and
an annular seal member that is made of a resilient material and that is integrated to the body so as to extend from the flange portion on a side thereof opposite the hollow cylindrical portion coaxially therewith.

2. The toilet flange of claim 1, wherein the annular seal member has a C-shaped section.

3. The toilet flange of claim 2, wherein the annular seal member is a main seal member; the toilet flange further comprising a secondary removable annular seal member attachable to the main seal member coaxially thereon; the secondary removable seal member conforms to the main seal member to define an extension thereof.

4. The toilet flange of claim 3, wherein the secondary removable annular seal member includes a main portion that has a C-shaped section and an annular skirt portion that extends from the main portion and that defines an annular hook which grabs onto the main seal member when the secondary removable annular seal member is coaxially mounted thereon.

5. The toilet flange of claim 1, wherein the annular seal member has a tapered profile.

6. The toilet flange of claim 1, wherein the annular seal member is accordion-shaped.

7. The toilet flange of claim 1, wherein the annular seal member has a rectangular annular portion and a rounded triangular-shaped annular portion extending coaxially from the rectangular annular portion on a first side thereof opposite the flange portion.

8. The toilet flange of claim 1, wherein the annular seal member has a hollow tube portion having, at a distal end thereof, an integral arcuate flange extending radially inwardly from the hollow tube portion.

9. The toilet flange of claim 1, wherein the flange portion is made of plastic.

10. The toilet flange of claim 9, wherein the annular seal member includes a sealing portion that extends from the flange portion of the body and a connector portion that is integrated to the flange portion of the body.

11. The toilet flange of claim 10, wherein the connector portion results from an overmolding of the annular seal member onto the flange portion.

12. The toilet flange of claim 1 wherein the flange portion includes two hold-down bolts housings that are so positioned relative to the hollow cylindrical portion to locate a toilet bowl onto the toilet flange.

13. The toilet flange of claim 1, wherein the body is one-piece.

14. The toilet flange of claim 13, wherein the body is made of plastic.

15. The toilet flange of claim 14, wherein the body results from a molding process.

16. The toilet flange of claim 15, wherein the annular seal member is integrated to the body during the molding process.

17. The toilet flange of claim 1, wherein the annular seal member is made of a non-permanently deformable material.

18. The toilet flange of claim 17, wherein the non-permanently deformable material is rubber.

19. The toilet flange of claim 1, wherein the annular seal member is integrated to the body using at least one of an adhesive and fasteners.

20. The toilet flange of claim 1, wherein the flange portion is rectangular.

21. A toilet flange comprising:
a one-piece plastic body that includes i) a hollow cylindrical portion having two longitudinal ends, and ii) a flange portion that extends radially outward from the hollow cylindrical portion at one of the two longitudinal ends thereof; and
an annular seal member that is made of a resilient material; the annular seal member having a sealing portion that extends from the flange portion of the one-piece plastic body and a connector portion that is integrated to the flange portion of the one-piece plastic body during a molding process so as to extend from the flange portion on a side thereof opposite the hollow cylindrical portion coaxially therewith.

22. A toilet flange comprising:
a body that is a made of a rigid material and that includes i) a hollow cylindrical portion having two longitudinal ends, and ii) a flange portion that extends radially outward from the hollow cylindrical portion at one of the two longitudinal ends thereof; the flange portion including two bolt-receiving housings that are so positioned relative to the hollow cylindrical portion to locate a toilet bowl onto the toilet flange.
